(19) United States
(12) Patent Application Publication
(10) Pub. No.: US 2018/0325263 A1
(43) Pub. Date: Nov. 15, 2018

(54) INTELLIGENT CHAIR BASE AND INTELLIGENT CHAIR COMPRISING THEREOF

(71) Applicants: SHANG SUNG CHIANG, TAIPEI (TW); MATTHEW CHIANG, TAIPEI (TW)

(72) Inventors: SHANG SUNG CHIANG, TAIPEI (TW); MATTHEW CHIANG, TAIPEI (TW)

(21) Appl. No.: 15/801,325

(22) Filed: Nov. 2, 2017

(30) Foreign Application Priority Data
Apr. 5, 2017 (TW) 106204670

(51) Int. Cl. A47C 7/00; B60K 7/00

(52) U.S. Cl. CPC A47C 7/002; A61G 5/04; B60K 7/0007

(57) ABSTRACT

Disclosed herein are an intelligent chair base and an intelligent chair comprising thereof. The intelligent chair base includes a base casing comprising a base control unit and a battery module, a touch module disposed on the surface of the base casing, a base movement mechanism disposed at the bottom of the base casing; a switching device disposed on the surface of the base housing, and a base electrical connection unit coupled to the base control unit and detachably connected to an external module. When the touch module communicates a signal to the base control unit, the base control unit controls the battery module to supply power to the base movement mechanism to move the intelligent chair base. The intelligent chair comprises the intelligent chair base and a chair holder.

### RELATED APPLICATIONS

This application claims priority to U.S. provisional application No. 62/440,416, filed Dec. 31, 2016 and Taiwanese Application Serial Number 106204670, filed on Apr. 5, 2017, which is herein incorporated by reference.

### BACKGROUND

This invention generally relates to an intelligent chair base and an intelligent chair comprising thereof. More particularly, the intelligent chair base is controlled by foot and is detachably mounted on a chair holder to form an intelligent chair.

### DESCRIPTION OF RELATED ART

In the past, human sit on a static chair only for handling affairs or taking a rest, but with the advance of science and technology, work efficiency should be greatly improved. Therefore, the present invention provided an intelligent chair base and an intelligent chair comprising thereof. Human can deal with affairs on the intelligent chair and move arbitrarily at the same time. Due to the intelligent chair base of the intelligent chair is controlled by foot, work efficiency would be enhanced.

The intelligent chair base of the present invention also has many functions so as to provide users high convenience and users would have much fun when using it.

### SUMMARY OF INVENTION

Therefore, the present invention provides an intelligent chair base comprises a base casing comprising a base control unit and a battery module, wherein the base control unit is coupled to the battery module for controlling the power supply thereof; a touch module disposed on the surface of the base casing and electrically connected to the base control unit wherein the touch module has a switching control unit; a base movement mechanism disposed at the bottom of the base casing and electrically connected to the base control unit; a switching device disposed on the surface of the base casing and electrically connected to the base control unit for controlling thereof; and a base electrical connection unit coupled to the base control unit and detachably connected to an external module, wherein the base control unit is for controlling the battery module to supply power to the external module, wherein the touch module communicates a signal to the base control unit, the base control unit controls the battery module to supply power to the base movement mechanism to move the intelligent chair base.

In an embodiment of the intelligent chair base of the present invention, the base control unit and the battery module are disposed on a substrate in the base casing.

In an embodiment of the intelligent chair base of the present invention, the base movement mechanism includes at least one caster disposed on the substrate; at least one driving wheel disposed on the substrate; and an actuating unit coupled to the caster and the base control unit; wherein the actuating unit is for driving the driving wheel to move the intelligent chair base along a driving direction and the caster is for changing the driving direction of the intelligent chair base.

In an embodiment of the intelligent chair base of the present invention, the base control unit is a microprocessor and the actuating unit is a motor.

In an embodiment of the intelligent chair base of the present invention, the intelligent chair base further comprises a port module, which is disposed on the surface of the base casing, coupled to the base control unit and optionally electrically connected to an external electronic device.

In an embodiment of the intelligent chair base of the present invention, the intelligent chair base further comprises a wireless communication, which is disposed in the base casing, coupled to the base control unit and optionally electrically connected to an external electronic device.

In an embodiment of the intelligent chair base of the present invention, the intelligent chair base further comprises a functional module, which is disposed in the base casing and coupled to the base control unit, wherein the base control unit controls the functional module to execute functions according to the signal delivered from the port module or the wireless communication module.

In an embodiment of the intelligent chair base of the present invention, the intelligent chair base further comprises a sensing module, which is disposed in the base casing and coupled to the base control unit.

In an embodiment of the intelligent chair base of the present invention, the sensing module of the intelligent chair base further comprises an object sensing unit and a pressure sensing unit.

In an embodiment of the intelligent chair base of the present invention, the intelligent chair base further comprises a lifting unit, which is disposed on the surface of the base casing and electrically connected to the base control unit.

The present invention also provides an intelligent chair, which comprises the intelligent chair base mentioned above and a chair holder, wherein and the chair holder is detachable from the intelligent chair base.

In an embodiment of the intelligent chair of the present invention, the chair holder comprises a chair holder control unit and a chair holder electrical connection unit coupled to the chair holder control unit, wherein the chair holder electrical connection unit is electrically connected to the base electrical connection unit of the intelligent chair base when the chair holder is placed on the intelligent chair base.

In an embodiment of the intelligent chair of the present invention, the base control unit is for controlling the power supply module to supply power to the chair holder through the base electrical connection unit.

In an embodiment of the intelligent chair of the present invention, the chair holder further comprises an actuator detecting module which is coupled to the chair holder control unit for detecting surrounding environment of the chair holder so as to produce a control signal to make the chair holder execute a corresponding function.

In an embodiment of the intelligent chair of the present invention, the chair holder further comprises a chair holder adjustable element.

The base electrical connection unit of the intelligent chair base of the present invention could be connected to any corresponding external modules, for example, such as the chair holder, but not limited thereto.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic representation of an intelligent chair base 100 in accordance with an embodiment of the present invention.

FIG. 2 is a schematic bottom plan view of an intelligent chair base 100 in accordance with an embodiment of the present invention.

FIG. 3 is a schematic block diagram of an intelligent chair base 100 in accordance with an embodiment of the present invention.

FIG. 4 is a schematic block diagram of an intelligent chair base 300 in accordance with an embodiment of the present invention.

FIG. 5 is a schematic block diagram of an intelligent chair base 400 in accordance with an embodiment of the present invention.

FIG. 6 is a schematic representation of an intelligent chair base 500 in accordance with an embodiment of the present invention.

FIG. 7 is a schematic block diagram of an intelligent chair base 500 in accordance with an embodiment of the present invention.

FIG. 8 is a schematic representation of an intelligent chair base 1000 in accordance with an embodiment of the present invention.

FIG. 9 is a schematic block diagram of an intelligent chair base 1000 in accordance with an embodiment of the present invention.

### DETAILED DESCRIPTION

The invention can be more fully understood by reading the following detailed description of the embodiment with reference made to the accompanying drawings that illustrate the invention and it should be noted that the drawings are not to scale and only for illustration only.

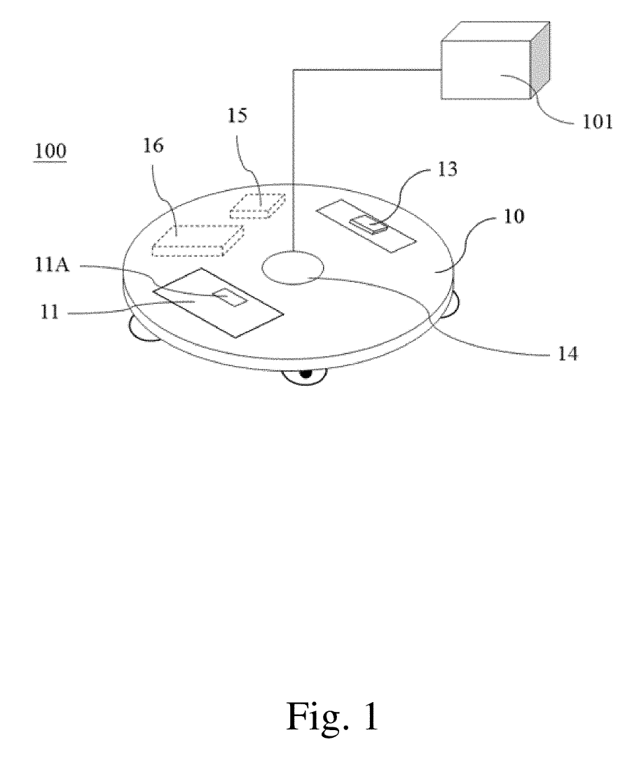

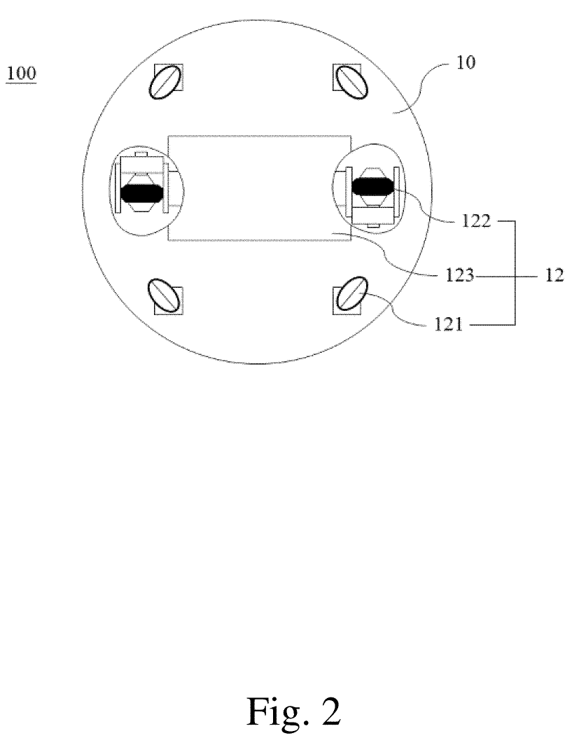

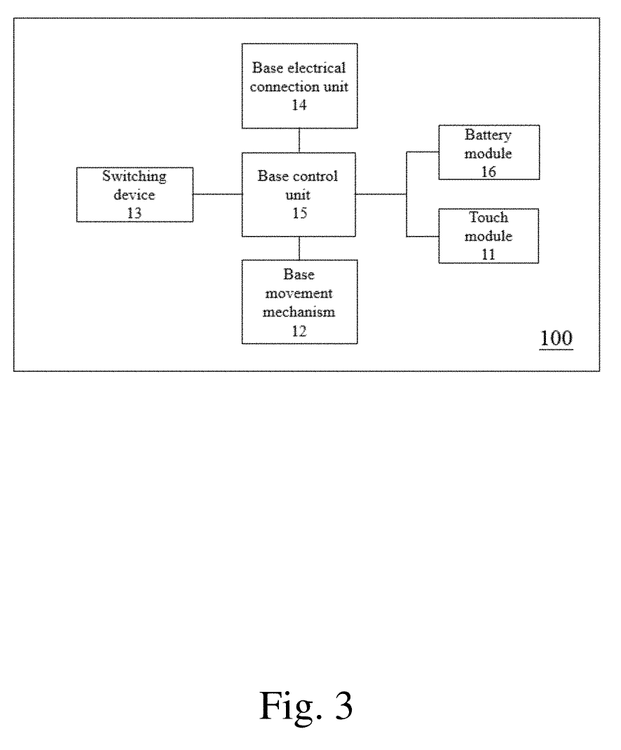

Now referring to FIG. 1 to FIG. 3, FIG. 1 is schematic representation of an intelligent chair base 100 in accordance with an embodiment of the present invention, FIG. 2 is a schematic bottom plan view of an intelligent chair base 100 in accordance with an embodiment of the present invention, and FIG. 3 is a schematic block diagram of an intelligent chair base 100 in accordance with an embodiment of the present invention.

In an aspect of the present invention, the intelligent chair base 100 disclosed in the present invention comprises a base casing 10, a touch module 11, a base movement mechanism 12, a switching device 13 and a base electrical connection unit 14. The base casing 10 comprises a base control unit 15 and a battery module 16, wherein the base control unit 15 is coupled to the battery module 16 for controlling the power supply thereof. The touch module 11 disposed on the surface of the base casing 10 and electrically connected to the base control unit 15 wherein the touch module 11 has a switching control unit 11A. The base movement mechanism 12 disposed at the bottom of the base casing 10 and electrically connected to the base control unit 15. The switching device 13 which is disposed on the surface of the base casing 10 and electrically connected to the base control unit 15 for controlling thereof. The base electrical connection unit 14 coupled to the base control unit 15 and detachably connected to an external module 101, wherein the base control unit 15 is for controlling the battery module 16 to supply power to the external module 101 through the base electrical connection unit 14.

According to the weight limits, the base casing 10 is made of material selected from the group consisting of plastic, stainless steel or aluminum alloy. The strength of stainless steel is higher than aluminum alloy but the advantage of the aluminum alloy is lightweight and excellent appearance.

In another aspect of the present invention, the base control unit 15 and the battery module 16 are fixed on a substrate in the base housing 10. In a preferred embodiment of the present invention, the base control unit 15 is such as, for example, a microprocessor. Considering required power, working environment, environmental or even cost, the battery module 16 is selected from the lithium ion battery, hydrogen fuel cell or lead-acid battery. Among these batteries, the lithium ion battery technology is most matured and can meet a wide range of requirements. The hydrogen fuel cell is the most environmentally friendly cell but the cost thereof is more expensive. Comparing with the lithium ion battery, the lead-acid battery is generally big, heavy and lower energy density, but the price of the lead-acid battery is cheaper and easily to be obtained.

The touch module 11 which is disposed on the surface of the base casing 10 and electrically connected to the base control unit 15. The touch module 11 has a switching control unit 11A. When a user controls the touch module 11 by foot, the touch module 11 would communicate a signal to the base control unit 15, then the base control unit 15 controls the battery module 16 to supply power to the base movement mechanism 12 to move the intelligent chair base 100. The touch interface of the touch module 11 is designed according to the user's demand and appearance concern but not limited to the FIG. 1.

In addition, the touch module 11 could be turned off by using of the switching control unit 11A.

Referring to FIG. 2 and FIG. 3, the base movement mechanism 12 which is disposed at the bottom of the base casing 10 and electrically connected to the base control unit 15. The base movement mechanism 12 includes at least one caster 121, at least one driving wheel 122 and an actuating unit 123 wherein the actuating unit 123 is coupled to the caster 121 and the base control unit 15. The actuating unit 123 is for driving the driving wheel 122 to move the intelligent chair base 100 along a driving direction and the caster 121 is for changing the driving direction of the intelligent chair base 100. In an aspect of the present invention, the caster 121 and the driving wheel 122 are disposed on a substrate in the base casing 10. In another preferred embodiment of the present invention, the base control unit 15 is a microprocessor and the actuating unit 123 is a motor.

The switching device 13 which is disposed on the surface of the base casing 10 and electrically connected to the base control unit 15 for controlling thereof. By using the switching device 13, the user could turn off the intelligent chair base 100.

The base electrical connection unit 14 which is coupled to the base control unit 15 and detachably connected to an external module 101, wherein the base control unit 15 is for controlling the battery module to supply power to the external module 101 through the base electrical connection unit 14. In another preferred embodiment of the present invention, the external module 101 is such as, for example a chair holder but not limited to.

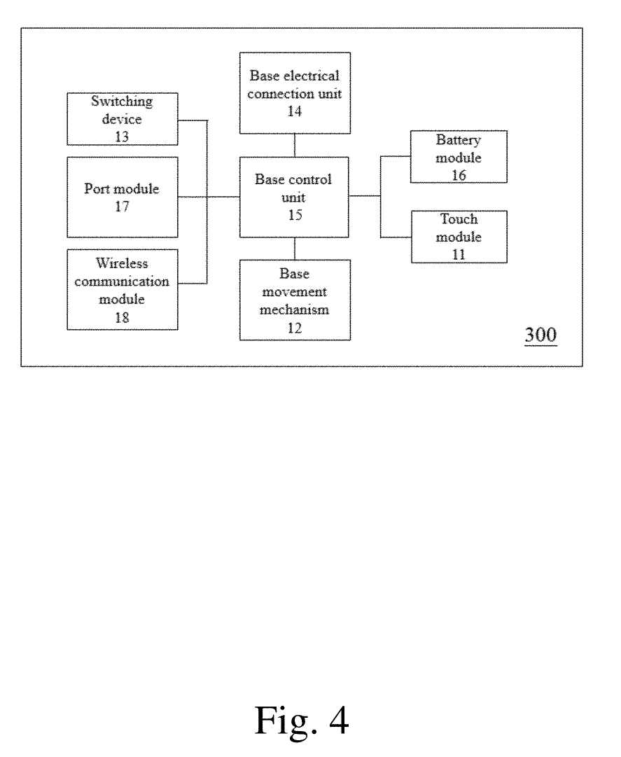

Referring to FIG. 4, FIG. 4 is a schematic block diagram of an intelligent chair base 300 in accordance with an embodiment of the present invention. The difference between the intelligent chair base 100 and the intelligent chair base 300 is the intelligent chair base 300 further comprises a port module 17 and a wireless communication module 18. In an aspect of the present invention, the port module 17 which is disposed on the surface of the base casing 10, coupled to the base control unit 15 and optionally electrically connected to an external electric device. In another aspect of the present invention, the wireless communication module 18 which is disposed in the base casing 10 and coupled to the base control unit 15. The wireless communication module 18 is optionally communicates a signal to an external electric device in a wireless way.

The external electric device is such as, for example, a cloud server, a smart phone, a desktop computer, an augmented reality device or a remote control, but not limited to.

In another preferred embodiment of the present invention, the external electric device is a remote control with built-in programs, the intelligent chair base 300 could be controlled by the signal emitted from the remote control. The built-in programs of the remote control is such as, for example, a constant distance program which is for keeping the intelligent chair base 300 and the remote control in a constant distance. In this way, the user only needs to carry the remote control and then the intelligent chair base 300 would trail after the user automatically in a constant distance. In another preferred embodiment of the present invention, the built-in programs of the remote control is a motion control program which is used for controlling the movement of the intelligent chair base.

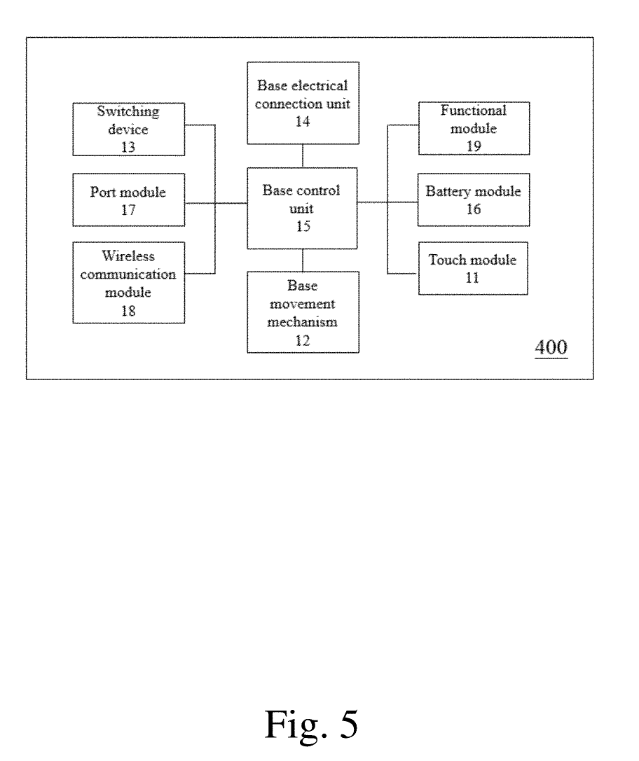

Referring to FIG. 5, FIG. 5 is a schematic block diagram of an intelligent chair base 400 in accordance with an embodiment of the present invention. The difference between the intelligent chair base 300 and the intelligent chair base 400 is the intelligent chair base 400 further comprises a functional module 19. In an aspect of the present invention, the functional module 19 which is disposed in the base casing 10 and coupled to the base control unit 15, wherein the base control unit 15 controls the functional module 19 to execute functions according to the signal delivered from the port module 17 or the wireless communication module 18. The functional module 19 is such as, for example, an audio module, a virtual reality module or a motion control module but not limited to. Through the audio module, users can listen to their favorite music. By using of the virtual reality module, users could sense movement or vibrations to enhance virtual reality experience. By using of the motion control module, the intelligent chair base could move to the specific area by automatic navigation system.

In another aspect of the present invention, the functional module 19 further includes a memory module 21 which is disposed in the base casing 10 of the intelligent chair and coupled to the functional module 19. The memory module 21 is used to memory the functions executed by the functional module 19 before. For example, to memory the route of the intelligent chair base. Therefore, even the switching control unit 11A of the touch module 11 has been turned off, the user also can utilize the memory module 21 to proceed various recreational activities.

In another aspect of the present invention, the intelligent chair base further includes a sensing module, which is disposed in the base casing and is coupled to the base control unit. The sensing module is such, for example capable of providing an object sensing function, a pressure sensing function, an image sensing function or a voice sensing function.

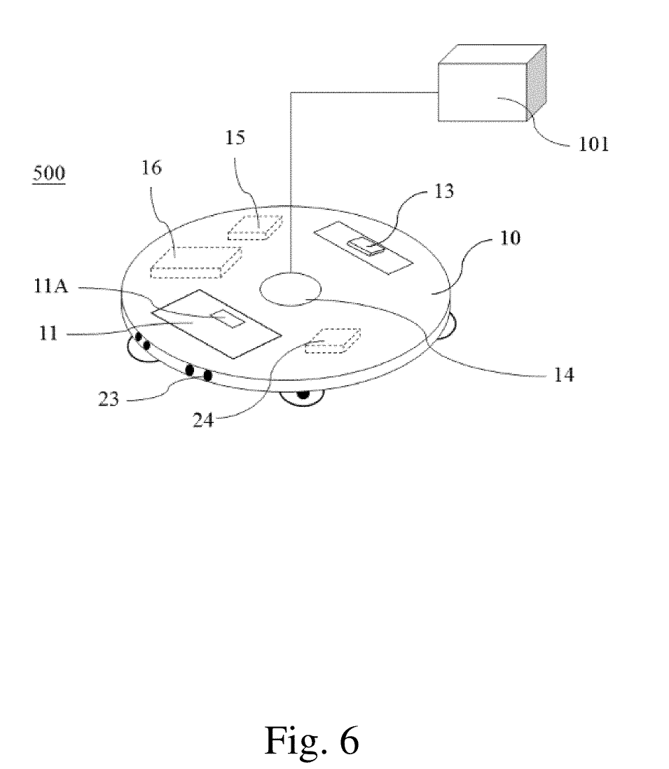

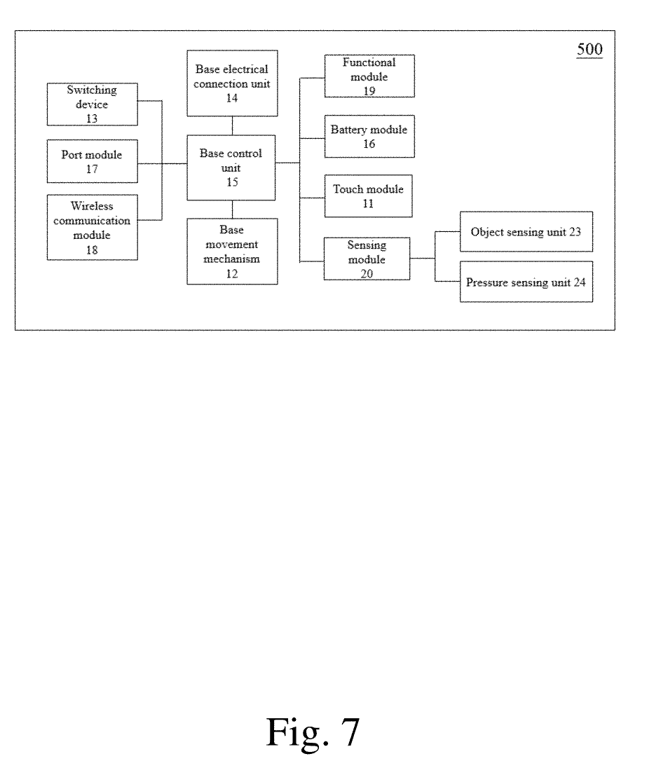

Referring to FIG. 6 and FIG. 7, FIG. 6 is a schematic representation of an intelligent chair base 500 in accordance with an embodiment of the present invention. FIG. 7 is a schematic block diagram of an intelligent chair base 500 in accordance with an embodiment of the present invention. The difference between the intelligent chair base 400 and the intelligent chair base 500 is the intelligent chair base 500 further comprises a sensing module 20 and a memory module 21. In an aspect of the present invention, the sensing module 20 which is disposed in the base casing 10 and coupled to the base control unit 15, wherein the sensing module 20 further includes an object sensing unit 23. The implementation method of the object sensing unit 23 is such as, for example a camera sensing device, an infrared sensor module, a sound wave sensing device or a temperature sensing device, but not limited to.

The aforementioned object sensing unit 23 is capable of sensing the obstacle around the intelligent chair base 500 to prevent the path is blocked or protect the intelligent chair base 500 from collision h an obstacle. When the road surface flat, such as a gap or a step, the object sensing unit 23 would generate a warming signal and transmit it to the base movement mechanism 12 through the base control unit 15 so as to change the path of the intelligent chair base 500 from falling from the step.

Further, the object sensing unit 23 has an advantage in that when users want to move the intelligent chair base 500 without using the touch module 11, the user just need to approach the intelligent chair base 500 so that the intelligent chair base 500 will automatically move in the specific direction at the same time. Also, if the intelligent chair base 500 is connected to the external module 101, the user can easily move the external module 101 though the intelligent chair base 500.

In an aspect of the present invention, the sensing module 20 of the intelligent chair base 500 further comprises a pressure sensing unit 24, which is disposed in the base casing 10 and coupled to the base control unit 15. When the intelligent chair base 500 is connected to the external module 101, the pressure sensing unit 24 is capable of detecting a change in gravity of the external module 101, so as to make the intelligent chair base 500 to execute the corresponding motion.

In an aspect of the present invention, the intelligent chair base further comprises a lifting unit, which is disposed on the surface of the base casing and electrically connected to the base control unit. When the intelligent chair base connects an external module, the external module could be lifted through the lifting unit of the intelligent chair base.

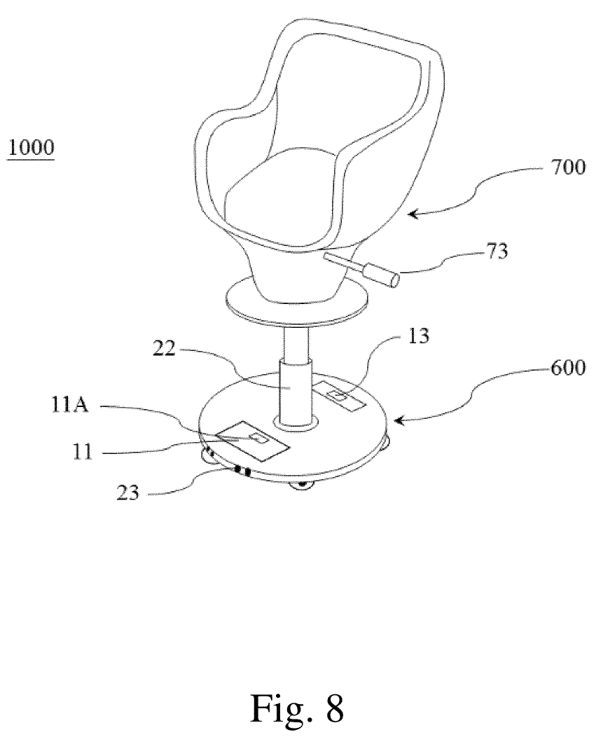

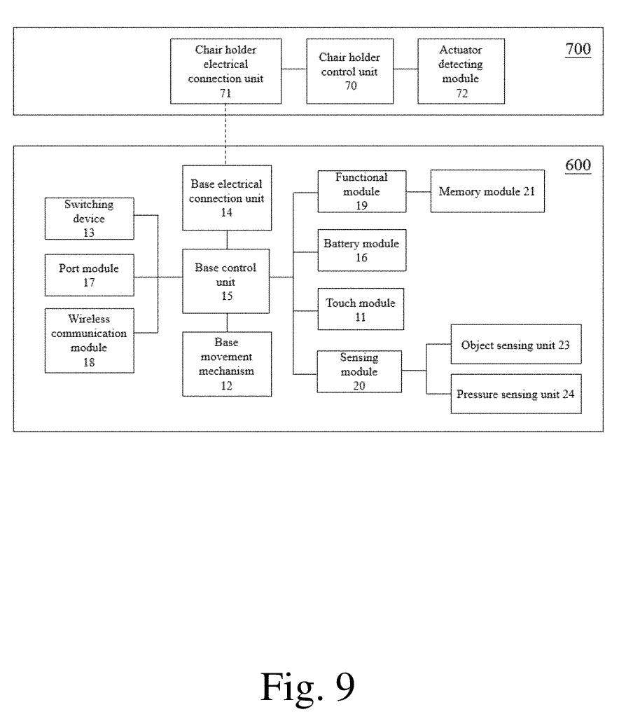

Referring to FIG. 8 and FIG. 9, FIG. 8 is a schematic representation of an intelligent chair base 1000 in accordance with an embodiment of the present invention. FIG. 9 is a schematic block diagram of an intelligent chair 1000 in accordance with an embodiment of the present invention. The intelligent chair 1000 comprises an intelligent chair base 600 and a chair holder 700. The difference between the intelligent chair base 500 and the intelligent chair base 600 is the intelligent chair base 600 includes a lifting unit 22, which is disposed on the surface of the base casing 10 and electrically connected to the base control unit 15. The lifting unit 22 is used for controlling the chair holder 700. The chair holder 700 is detachable from the intelligent chair base 600. The chair holder 700 comprises a chair holder control unit 70 and a chair holder electrical connection unit 71 which is coupled to the chair holder control unit 70. When the chair holder 700 is set on the intelligent chair base 600, the chair holder electrical connection unit 71 of the chair holder 700 is electrically connected to the base electrical connection unit 14 of the intelligent chair base 600. In an embodiment of present invention, when the base the chair holder electrical connection unit 71 of the chair holder 700 is electrically connected to the base electrical connection unit 14 of the intelligent chair base 600, the base control unit 15 would control the battery module 16 to supply power to the chair holder 700 so that the chair holder control unit 70 and other modules of the chair holder 700 can obtain the power supply at the same time.

The appearance of the chair holder 700 of the present invention is like the general seat used for sitting and the surface of the chair holder could be covered with an anti-slip layer thereon, which is made of rubber or silicone to make person feel comfortable an safe when sitting on it. The material formed of the chair holder 700 is selected from PC, ABS, or glass fiber composite material. Also the chair holder 700 further comprises a chair holder adjustable element 73 which is disposed on the seat holder 700. According to the user's habit, the user can arbitrarily adjust the inclination angle of the chair holder 700 by utilizing the chair holder adjustable element 73.

In an aspect of the present invention, the chair holder also includes a port module and a wireless communication. The detailed content related to the port module and a wireless communication has mentioned above and not repeated again. In the embodiment of the present invention, the chair holder could be controlled through the port module and a wireless communication for adjusting the chair holder adjustable element.

In the intelligent chair base 600 of the intelligent chair 1000 of the present invention, the sensing module 20 further includes a sensing unit 24, when the center of gravity of the user sitting on the chair holder 700 is shifted, the sensing unit 24 would transmit a control signal to the base control unit 15 to make the base movement mechanism 12 of the intelligent chair base 600 to proceed the corresponding movement. For example, when the center of gravity of the user is shifted to the right, and the intelligent chair base 600 would move toward to right direction, on the country, when the center of gravity of the user is shifted to the left, and the intelligent chair base 600 would move toward to left direction. Further, when the center of gravity of the user is shifted forward, the intelligent chair base 600 would move toward and vice versa. Therefore, according to the requirement of the user, the intelligent chair base 600 can be controlled by foot through the touch module 11, controlled by the center of gravity through sensing unit 24 of the sensing module 20 or the combination thereof. If the user choose the center of gravity control mode, the user just need to turn off the switching control unit 11A.

The chair holder 700 further includes an actuator detecting module 72 which is coupled to the chair holder control unit 70. The actuator detecting module 72 would produce a control signal to the chair holder control unit 70 of the chair holder 700 to make the chair holder 700 execute the corresponding rotation relative to the intelligent chair base 600. The detecting method of the actuator detecting module 72 is such as, for example a pressure sensing, a camera sensing, an infrared sensor module, a sound wave sensing device or a temperature sensing device, but not limited to.

In the intelligent chair 1000 disclosed in the present invention, the sensing module 20 of the intelligent chair base 600 could built in the specific gesture or specific sound indication of the user, so that the sensing module 20 could identify according the built-in program so as to transmit the base control unit 15 to execute the corresponding functions. For example, when the user provides a foot shake pose, the sensing module 20 would produce a control signal to the base control unit 15 to make the intelligent chair base 600 move back automatically to user's back. Also, the actuator detecting module 72 is capable of sensing the proximity of the user's synchronously so as to rotate the chair holder 700 immediately in a relative position with the intelligent chair base for providing the user with convenience experience.

The intelligent chair base of the present invention is could be a versatile base. It is not only used to connect a chair holder to form an intelligent chair, but also be connected to many external modules with different functions. The external modules is also could be a device that has a specific function, such as, for example a small refrigerators, small dehumidifiers, fans or other small power equipment. When these external modules or devices are connected to the intelligent chair base of the present invention, the external modules or devices can obtain the power supply through the battery module of the intelligent chair base. Besides, the external modules or devices can be moved easily through the base movement mechanism of the intelligent chair base of the present invention.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An intelligent chair base including:
a base casing comprising a base control unit and a battery module, wherein the base control unit is coupled to the battery module for controlling the power supply thereof.
a touch module disposed on the surface and electrically connected to the base control unit wherein the touch module has a switching control unit;
a base movement mechanism disposed at the bottom of the base casing and electrically connected to the base control unit;
a switching device disposed on the surface of the base casing and electrically connected to the base control unit for controlling thereof; and
a base electrical connection unit coupled to the base control unit and detachably connected to an external module, wherein the base control unit is for controlling the battery module to supply power to the external module through the base electrical connection unit;
wherein the touch module communicates a signal to the base control unit, the base control unit controls the battery module to supply power to the base movement mechanism to move the intelligent chair base.

2. The intelligent chair base of claim 1, wherein the base control unit and the battery module are disposed on a substrate in the base casing.

3. The intelligent chair base of claim 2, wherein the base movement mechanism includes;
at least one caster disposed on the substrate;
at least one driving wheel disposed on the substrate; and
an actuating unit coupled to the caster and the base control unit;
wherein the actuating unit is for driving the driving wheel to move the intelligent chair base along a driving direction and the caster is for changing the driving direction of the intelligent chair base.

4. The intelligent chair base of claim 3, wherein the base control unit is a microprocessor and the actuating unit is a motor.

5. The intelligent chair base of claim 1, further comprises a port module, which is disposed on the surface of the base casing, coupled to the base control unit and optionally electrically connected to an external electronic device.

6. The intelligent chair base of claim 1, further comprises a wireless communication module, which is disposed in the base casing, coupled to the base control unit and optionally electrically connected to an external electronic device.

7. The intelligent chair base of claim 5 or 6, further comprises a functional module, which is disposed in the base casing and coupled to the base control unit, wherein the base control unit controls the functional module to execute functions according to the signal delivered from the port module or the wireless communication module.

8. The intelligent chair base of claim 1, further comprises a sensing module, which is disposed in the base casing and coupled to the base control unit.

9. The intelligent chair base of claim 8, wherein the sensing module includes an object sensing unit and a pressure sensing unit.

10. The intelligent chair base of claim 1, further comprises a lifting unit, which is disposed on the surface of the base casing and electrically connected to the base control unit.

11. An intelligent chair comprises the intelligent chair base according to claim 1 to claim 10, and a chair holder, wherein the chair holder is detachable from the intelligent chair base.

12. The intelligent chair of claim 11, wherein the chair holder comprises;
a chair holder control unit; and
a chair holder electrical connection unit coupled to the chair holder control unit;
wherein the chair holder electrical connection unit is electrically connected to the base electrical connection unit when the chair holder is placed on the intelligent chair base.

13. The intelligent chair of claim 12, wherein when the chair holder is placed on the intelligent chair base, the base control unit is for controlling the power supply module to supply power to the chair holder through the base electrical connection unit.

14. The intelligent chair of claim 12, the chair holder further comprises an actuator detecting module which is coupled to the chair holder control unit for detecting surrounding environment of the chair holder and producing a control signal to make the chair holder execute a corresponding function.

15. The intelligent chair of claim 11, further comprises a chair holder adjustable element.
